(19) United States
(12) Patent Application Publication
(10) Pub. No.: US 2026/0194858 A1
(43) Pub. Date: Jul. 9, 2026

(54) ESCAPEMENT MECHANISM OF A TIMEPIECE

(71) Applicant: Rolex SA, Genève 26 (CH)

(72) Inventors: Fabiano COLPO, Lausanne (CH); Olivier KARLEN, Blonay (CH); Quentin PETER, Vésenaz (CH); Xuan Mai TU, Ecublens (CH)

(21) Appl. No.: 19/440,386

(22) Filed: Jan. 5, 2026

(30) Foreign Application Priority Data
Jan. 9, 2025 (EP) 25151032.7

(51) Int. Cl. G04B 15/14

(52) U.S. Cl. CPC G04B 15/14

(57) ABSTRACT

An escapement device of a timepiece comprises an escapement mobile element comprising a plurality of blocking teeth, a blocking mobile element, provided to block and unblock said at least one escapement mobile element), receive and transmit an impulse during the same vibration of the oscillator. The blocking device is arranged to cooperate with a first blocking tooth from the plurality of blocking teeth to unblock said at least one escapement mobile element during an intermediate unblocking step, and cooperate with a second blocking tooth from the plurality of blocking teeth, different from said first blocking tooth, during an impulse step.

### CROSS-REFERENCE TO RELATED APPLICATIONS

The present application claims priority to European Application No. 25151032.7 filed with the European Patent Office on Jan. 9, 2025, which is incorporated herein by reference in its entirety for all purposes.

### TECHNICAL FIELD OF THE INVENTION

The present invention generally relates to an escapement device for a mechanical timepiece. Particularly, the present invention may relate to an escapement device comprising two escapement wheels. According to one aspect, the present invention may relate to an escapement device comprising escapement wheels provided to give impulses, particularly tangential impulses, to a blocking mobile element of the escapement device for a timepiece, particularly a mechanical timepiece.

### STATE OF THE ART

Escapement devices are known in the prior art to propose, as shown in the Application EP4198641, a natural escapement comprising two escapement wheels each provided to cooperate on the one hand with an articulated lever, and on the other hand with impulse pallets provided on the balance to ensure a direct cooperation with either of the two escapement wheels. However, such an escapement device is bulky and comprises a complex mechanism.

Document EP1367462 discloses a double indirect impulse escapement device, which comprises two escapement mobile elements meshing with each other and cooperating with a single blocking mobile element. During the rest phases, the blocking mobile element abuts on detent pins and the unblocking causes significant stresses and friction, which impairs the overall efficiency.

Document CH714200 discloses an escapement device which comprises two escapement mobile elements meshing with each other and cooperating with the same lever. During the impulse phases, the mobile element giving the impulse pivots in the same direction as the lever, which causes friction and efficiency losses.

### DISCLOSURE OF THE INVENTION

One aim of the present invention is to address the drawbacks of the prior art mentioned above and particularly, firstly, to propose an escapement device that is simple to manufacture and/or assemble, and/or that has high operating efficiency, and/or that has improved shock and/or friction sensitivity, and/or a better compromise between these constraints.

To this end, a first aspect of the invention relates to an escapement device of a timepiece, comprising:
at least one escapement mobile element arranged to be in engagement with a drive gear train of the timepiece and comprising a plurality of blocking teeth,
at least one blocking mobile element, provided to:
   block said at least one escapement mobile element during a rest step,
   unblock said at least one escapement mobile element during an intermediate unblocking (or unlocking) step at the end of the rest step,
   receive from said at least one escapement mobile element an impulse during an impulse step,
   transmit at least part of the received impulse to an oscillator of the timepiece,
characterized in that, during a same vibration of the oscillator, the blocking mobile element is arranged to:
cooperate with a first blocking tooth from the plurality of blocking teeth to unblock said at least one escapement mobile element during the intermediate unblocking step,
cooperate with a second blocking tooth from the plurality of blocking teeth, different from said first blocking tooth, to receive from said at least one escapement mobile element the impulse during the impulse step subsequent to said intermediate unblocking step.

According to the implementation above, the blocking mobile element cooperates with one blocking tooth during the intermediate unblocking step, and with another blocking tooth during the impulse step subsequent to said intermediate unblocking step (the impulse step being immediately subsequent to said intermediate unblocking step). Thus, the unblocking function and the function of the impulse that follows the unblocking are ensured by different teeth of the escapement mobile element. Such an implementation allows designing specifically the shapes (on the blocking mobile element and/or on the escapement mobile element) necessary for the unblocking and for the impulse with greater freedom and/or with fewer constraints to consider and/or in an independent manner.

The escapement device may have the following characteristics, taken individually or in combination.

According to one embodiment, the escapement device is an indirect-impulse escapement device. According to one embodiment, the escapement device is arranged to deliver impulses to the oscillator of the timepiece exclusively via the blocking mobile element. In other words, only the blocking mobile element cooperates directly with the oscillator of the timepiece and transmits impulses to the oscillator of the timepiece.

According to one embodiment, said at least one escapement mobile element transmits impulses exclusively to the blocking mobile element. Particularly, said at least one escapement mobile element does not transmit directly the impulses to the oscillator of the timepiece.

According to one embodiment, the blocking mobile element is planar. According to this embodiment, the blocking mobile element is planar and has a thickness, and the blocking mobile element comprises lateral surfaces (of a height defined by the thickness of the blocking mobile element) to cooperate with the blocking teeth of said at least one escapement mobile element. In other words, the blocking mobile element is planar and comprises an upper planar surface, a lower planar surface, and the lateral surfaces of the blocking mobile element provided to cooperate with the blocking teeth of said at least one escapement mobile element are arranged between the upper planar surface and the lower planar surface or connect them.

According to one embodiment, the blocking mobile element is free of (blocking or impulse) pallets. According to one embodiment, the blocking mobile element is in one piece or integral.

According to one embodiment, said at least one escapement mobile element is planar. According to this embodiment, said at least one escapement mobile element is planar and has a thickness, and said at least one escapement mobile element comprises lateral surfaces (of a height defined by the thickness of said at least one escapement mobile element) to cooperate with the blocking mobile element. Particularly, the blocking teeth comprise lateral surfaces (of a height defined by the thickness of said at least one escapement mobile element) to cooperate with the blocking mobile element. According to one embodiment, said at least one escapement mobile element is formed or comprises or consists of a single escapement wheel. In other words, said at least one escapement mobile element is planar and comprises un upper planar surface, a lower planar surface, and the lateral surfaces of said at least one escapement mobile element formed on the blocking teeth and provided to cooperate with the blocking mobile element are arranged between the upper planar surface and the lower planar surface or connect them.

According to one embodiment, said at least one escapement mobile element is coplanar with the blocking mobile element.

According to one embodiment, the oscillator is provided to have oscillations (back-and-forth movements) between two extreme positions, and the forward movement is considered as one vibration, and the return movement as another vibration.

According to one embodiment, said first blocking tooth, at least at the beginning of the intermediate unblocking step, is arranged to exert on the blocking mobile element a blocking force orthogonal, or substantially orthogonal, to a straight line passing through an axis of rotation of said at least one escapement mobile element and through a point of contact between said at least one escapement mobile element and the blocking mobile element (the point of contact being located between the first blocking tooth of the escapement mobile element and the blocking mobile element). Such an orthogonal force allows guaranteeing low variability in the friction forces and/or a low unblocking force between the escapement mobile element and the blocking mobile element during the intermediate unblocking step. Consequently, the efficiency is improved and/or the untimely stresses are avoided.

According to one embodiment, the blocking mobile element is arranged to cooperate with the first blocking tooth from the plurality of blocking teeth to block said at least one escapement mobile element during the rest step. In other words, the same blocking tooth is involved in the rest step and the intermediate unblocking step.

Alternatively, the blocking mobile element is arranged to cooperate with the second blocking tooth from the plurality of blocking teeth to block said at least one escapement mobile element during the rest step. According to this embodiment, the first blocking tooth interacts with the blocking mobile element only during the intermediate unblocking step.

According to one embodiment, said first blocking tooth, during the rest position, is arranged to exert a blocking force passing through, or substantially through, an axis of rotation of the blocking mobile element. The rest position is stable because the blocking force passing through, or substantially through, the axis of rotation of the blocking mobile element does not create a banking torque.

According to one implementation, the blocking mobile element is arranged to occupy two distinct rest positions, and the escapement device (or the timepiece) is free of abutments (or detent pins) to hold the blocking mobile element in either of the rest positions (or at least to prevent the blocking mobile element from exceeding either of the rest positions). According to one alternative, the escapement device (or the timepiece) comprises abutments (or detent pins) to hold the blocking mobile element in either of the rest positions (or at least to prevent the blocking mobile element from exceeding either of the rest positions).

According to one embodiment, the blocking mobile element comprises at least one unblocking surface portion and/or at least one blocking surface portion arranged to cooperate with said first blocking tooth during the intermediate unblocking step, and said at least one unblocking surface portion and/or said at least one blocking surface portion is arranged to face an axis of rotation of the blocking mobile element, and/or a line perpendicular to the unblocking surface portion or to the blocking surface portion is directed towards the axis of rotation of the blocking mobile element and forms, with a straight line passing through the axis of rotation of the blocking mobile element and through a point of contact between said at least one escapement mobile element and the blocking mobile element (the point of contact being located between the first blocking tooth of the escapement mobile element and the blocking mobile element), an angle γ of less than 30°, preferably less than 20°, during the rest step or during the intermediate unblocking step. According to this implementation, said at least one unblocking surface portion and/or said at least one blocking surface portion is generally arranged to face the axis of rotation of the blocking mobile element, such that the blocking force (typically normal to the blocking surface) generated by the escapement mobile element on the blocking mobile element is a tensile force on the blocking mobile element and/or passes through the axis of rotation of the blocking mobile element. The rest position is therefore stable, with a low or zero banking torque. According to one embodiment, said at least one unblocking surface portion and/or said at least one blocking surface portion form(s) blocking means.

According to one embodiment, the blocking mobile element comprises said at least one unblocking surface portion and said at least one blocking surface portion,

said at least one unblocking surface portion and said at least one blocking surface portion are adjacent and separated by a bearing point, and the blocking surface portion (or a tangent to the blocking surface portion and passing through the bearing point) and the unblocking surface portion (or a tangent to the unblocking surface portion and passing through the bearing point) preferably form an angle (typically having the bearing point as its vertex) comprised in a range of values from 140° to 170°. According to one embodiment, said at least one unblocking surface portion and said at least one blocking surface portion form a concavity within the blocking means.

According to one embodiment, said first blocking tooth and said second blocking tooth are subsequent or adjacent. In other words, the escapement mobile element does not comprise an “intermediate” blocking tooth between the (first) blocking tooth that ensures the rest and/or the blocking of the blocking mobile element and/or the unblocking, and the (second) tooth that will participate in the immediately subsequent impulse. The escapement mobile element comprises few teeth and is small in size. By subsequent or adjacent blocking teeth, it is meant blocking teeth located in the same plane and, in fact, forming part of the same toothing, and which follow each other. In other words, and according to one particular embodiment, said first blocking tooth and said second blocking tooth are subsequent or adjacent, and arranged in the same plane, for example the same plane as the plane of said at least one escapement mobile element and/or in the same plane as the plane of the blocking mobile element.

According to one embodiment, a rotation of the blocking mobile element and a rotation of the escapement mobile element during the impulse step are in opposite directions. In other words, the escapement device is of the tangential impulse type.

According to one embodiment, the escapement device comprises:
a first escapement mobile element pivotally mounted about a first axis of rotation, arranged to be in engagement with the drive gear train of the timepiece, and comprising a plurality of first blocking teeth,
a second escapement mobile element pivotally mounted about a second axis of rotation (typically different or distinct from the first axis of rotation, since it is called “second axis of rotation”), in engagement with the first escapement mobile element, and comprising a plurality of second blocking teeth,
in which the blocking mobile element is pivotally mounted about a third axis of rotation, and:
during a first vibration of the oscillator, the blocking mobile element is arranged to:
   cooperate with a first blocking tooth from the plurality of first blocking teeth to unblock the first escapement mobile element, during a first intermediate unblocking step, at the end of a first step called first-rest step,
   cooperate with a second blocking tooth from the plurality of first blocking teeth, different from said first blocking tooth, to receive from the first escapement mobile element an impulse during a second step called first-impulse step, subsequent to said first intermediate unblocking step,
during a second vibration of the oscillator, the blocking mobile element is arranged to:
   cooperate with a first blocking tooth from the plurality of second blocking teeth to unblock the second escapement mobile element, during a second intermediate unblocking step, at the end of a third step called second-rest step;
   cooperate with a second blocking tooth from the plurality of second blocking teeth, different from said first blocking tooth, to receive from the second escapement mobile element an impulse during a fourth step called second-impulse step, subsequent to said second intermediate unblocking step.

According to the embodiment above, during the first vibration of the oscillator, the blocking mobile element is arranged to cooperate with the first escapement mobile element and not with the second escapement mobile element. During the second vibration of the oscillator, the blocking mobile element is arranged to cooperate with the second escapement mobile element and not with the first escapement mobile element. According to the embodiment above and during the first vibration of the oscillator, the blocking mobile element cooperates with one blocking tooth (of the first escapement mobile element) during the first intermediate unblocking step, and with another blocking tooth (of the first escapement mobile element) during the impulse step subsequent to said intermediate unblocking step (the impulse step being immediately subsequent to said intermediate unblocking step). During the second vibration of the oscillator, the blocking mobile element cooperates with one blocking tooth (of the second escapement mobile element) during the second intermediate unblocking step, and with another blocking tooth (of the second escapement mobile element) during the impulse step subsequent to said intermediate unblocking step (the impulse step being immediately subsequent to said intermediate unblocking step). Thus, the unblocking function and the function of the impulse that follows the unblocking are ensured by different teeth of each escapement mobile element. Such an implementation allows specifically designing the shapes (on the blocking mobile element and/or on the escapement mobile element) necessary for the unblocking and the impulse with greater freedom and/or with fewer constraints to consider and/or in an independent manner.

According to one embodiment, the blocking mobile element comprises:
a first unblocking surface portion and/or a first blocking surface portion arranged to cooperate with said first blocking tooth from the plurality of first blocking teeth,
a second unblocking surface portion and/or a second blocking surface portion arranged to cooperate with said first blocking tooth from the plurality of second blocking teeth,
and:
the first unblocking surface portion and the second unblocking surface portion are arranged facing each other, and/or
the first blocking surface portion and the second blocking surface portion are arranged facing each other. According to this implementation, said first or second unblocking surface portion and/or said first or second blocking surface portion is/are generally arranged to face the axis of rotation of the blocking mobile element, so that the blocking force (typically normal to the blocking surface) generated by the first or second escapement mobile element is a tensile force on the blocking mobile element and/or passes through its axis of rotation. The rest positions are therefore stable, with a low or zero banking torque. According to one embodiment, the first unblocking surface portion and/or the first blocking surface portion form(s) first blocking means. According to one embodiment, the second unblocking surface portion and/or the second blocking surface portion form(s) second blocking means.

According to one embodiment, the blocking mobile element comprises:
the first unblocking surface portion and the first blocking surface portion,
the second unblocking surface portion and the second blocking surface portion,
and:
the first unblocking surface portion and the first blocking surface portion are adjacent and separated by a first bearing point, the first unblocking surface portion (or a tangent to the first unblocking surface portion and passing through the bearing point) and the first blocking surface portion (or a tangent to the first blocking surface portion and passing through the bearing point) preferably form an angle comprised in a range of values from 140° to 170°,
the second unblocking surface portion and the second blocking surface portion are adjacent and separated by a second bearing point, the second unblocking surface portion (or a tangent to the second unblocking surface portion and passing through the bearing point) and the second blocking surface portion (or a tangent to the second blocking surface portion and passing through the bearing point) preferably form an angle comprised in a range of values from 140° to 170°. In other words, the first unblocking surface portion and the first blocking surface portion form a first concavity within the first blocking means, and/or the second unblocking surface portion and the second blocking surface portion form a second concavity within the second blocking means.

According to one embodiment, a triangle whose vertices are the third axis of rotation, the first bearing point and the second bearing point, has at the vertex of the third axis of rotation an angle greater than 150°. In other words, the third axis of rotation, the first bearing point and the second bearing point are aligned or nearly aligned, which ensures that the blocking force (typically normal to the blocking surface) generated by the first or the second escapement mobile element on the blocking mobile element is a tensile force on the blocking mobile element and/or passes through the axis of rotation of the blocking mobile element. The rest position is therefore stable, with a low or zero banking torque. According to one embodiment, the triangle whose vertices are the third axis of rotation, the first bearing point and the second bearing point, has at the vertex of the third axis of rotation an angle greater than 175° or even an angle equal to 180° (it is then a flat triangle).

According to one embodiment:
during the first intermediate unblocking step, the first escapement mobile element and the blocking mobile element pivot in identical directions of rotation.
during the second step called first-impulse step, the first escapement mobile element and the blocking mobile element pivot in opposite directions of rotation.
during the second intermediate unblocking step, the second escapement mobile element and the blocking mobile element pivot in identical directions of rotation.
during the fourth step called second-impulse step, the second escapement mobile element and the blocking mobile element pivot in opposite directions of rotation. In other words, the escapement device is of the tangential drive type, which limits friction losses.

According to one embodiment:
during the first intermediate unblocking step, the first blocking tooth from the plurality of first blocking teeth is arranged to exert on the blocking mobile element a first blocking force orthogonal, or substantially orthogonal, to a straight line passing through the first axis of rotation and through a point of contact between the first escapement mobile element and the blocking mobile element (the point of contact being located between the first blocking tooth of the first escapement mobile element and the blocking mobile element), and/or the first blocking force passes through, or substantially through, the third axis of rotation,
during the second intermediate unblocking step, the first blocking tooth from the plurality of second blocking teeth is arranged to exert on the blocking mobile element a second blocking force orthogonal, or substantially orthogonal, to a straight line passing through the second axis of rotation and through a point of contact between the second escapement mobile element and the blocking mobile element (the point of contact being located between the first blocking tooth of the second escapement mobile element and the blocking mobile element), and/or the second blocking force passes through, or substantially through, the third axis of rotation. Such orthogonal forces guarantee low variability in the friction forces and/or a low unblocking force between the escapement mobile element and the blocking mobile element during the intermediate unblocking step. Consequently, the efficiency is improved and/or the unnecessary stresses are avoided.

According to one embodiment, the first escapement mobile element and/or the second escapement mobile element comprises a driving toothing provided to allow the first escapement mobile element to drive the second escapement mobile element. According to one embodiment, the driving toothing is distinct from the first or second blocking teeth. According to one embodiment, the driving toothing comprises branches that have a substantially uniform thickness and/or that are curved. According to one embodiment, the driving toothing cooperates with the first or second blocking teeth to drive the second escapement mobile element in movement. More specifically, the first escapement mobile element comprises a first driving toothing and the second escapement mobile element comprises a second driving toothing provided to cooperate or mesh and allow the first escapement mobile element to drive the second escapement mobile element in movement.

According to one embodiment, the blocking mobile element comprises a fork arranged to cooperate with the oscillator and has a plane of symmetry passing through the middle of the fork.

According to one embodiment, the blocking mobile element is planar.

According to one embodiment, the first escapement mobile element and/or the second escapement mobile element is planar. According to another embodiment, the first escapement mobile element and the second escapement mobile element are identical.

According to one embodiment, the blocking mobile element and/or the first escapement mobile element and/or the second escapement mobile element is made of a metal alloy.

According to one embodiment, the blocking mobile element and/or the first escapement mobile element and/or the second escapement mobile element is made of a metal alloy, for example, nickel-phosphorus, and/or is formed by an electrodeposition technique.

According to one embodiment, the blocking mobile element and/or the first escapement mobile element and/or the second escapement mobile element is made of silicon, and/or formed of a silicon-based material.

According to one embodiment, the blocking mobile element and/or the first escapement mobile element and/or the second escapement mobile element is made of an amorphous material or at least partially amorphous material.

A second aspect of the invention relates to a method for sustaining the oscillations of an oscillator in a timepiece, the timepiece comprising at least:
an oscillator arranged to have periodic oscillations (each comprising two vibrations),
a drive gear train arranged to generate a drive force, comprising for example a mainspring such as a barrel spring,
an escapement device arranged between the oscillator and the drive gear train, comprising at least a first escapement mobile element movable in rotation and comprising a plurality of first blocking teeth, a second escapement mobile element movable in rotation, comprising a plurality of second blocking teeth and engaged with the first escapement mobile element, and a blocking mobile element movable in rotation,
the method for sustaining the oscillations comprising at least:
a first step called first-rest step, during which the first escapement mobile element cooperates with the blocking mobile element so as to block the blocking mobile element in a first blocking position,
a second step called first-impulse step, during which the first escapement mobile element drives the blocking mobile element along a first predefined impulse path,
a third step called second-rest step, during which the second escapement mobile element cooperates with the blocking mobile element so as to block the blocking mobile element in a second blocking position,
a fourth step called second-impulse step, during which the second escapement mobile element drives the blocking mobile element along a second predefined impulse path.

According to one embodiment, the method for sustaining the oscillations comprises:
a first intermediate unblocking (or unlocking) step, interposed between the first step called first-rest step and the second step called first-impulse step, during which the first escapement mobile element and the blocking mobile element pivot in a same first direction of rotation, and/or
a second intermediate unblocking step, interposed between the third step called second-rest step and the fourth step called second-impulse step, during which the second escapement mobile element and the blocking mobile element pivot in a same second direction of rotation.

According to one embodiment:
the first intermediate unblocking step is implemented by the cooperation of the blocking mobile element and of a first blocking tooth from the plurality of first blocking teeth, and preferably ends with a first pre-impulse step consisting in transmitting to the blocking mobile element part of the impulse via the first tooth from the plurality of first blocking teeth, the second step called first-impulse step being implemented by the cooperation of the blocking mobile element and of a second tooth from the plurality of first blocking teeth, and/or
the second intermediate unblocking step is implemented by the cooperation of the blocking mobile element and of a first blocking tooth from the plurality of second blocking teeth, and preferably ends with a second pre-impulse step consisting in transmitting part of the impulse via the first tooth from the plurality of second blocking teeth, the fourth step called second-impulse step being implemented by the cooperation of the blocking mobile element and of a second tooth from the plurality of second blocking teeth.

### DESCRIPTION OF THE FIGURES

Other characteristics and advantages of the present invention will become more apparent upon reading the following detailed description of embodiment(s) of the invention given by way of non-limiting example(s) and illustrated by the appended drawings, in which:

FIG. 1 represents a front view of an escapement device according to the invention, comprising in particular a first escapement mobile element, a second escapement mobile element and a blocking mobile element, provided to cooperate with an oscillator of a timepiece;

FIG. 2 represents a front view of the blocking mobile element of the escapement device of FIG. 1;

FIG. 3 represents detailed views of the blocking surface portions and unblocking surface portions of the blocking mobile element;

FIG. 4 represents a front view of one variant of embodiment of the blocking mobile element of the escapement device of FIG. 1;

FIG. 5 represents a first step called first rest-rest step of the escapement device of FIG. 1, in which the first escapement mobile element is blocked by the blocking mobile element via a first blocking tooth of the first escapement mobile element;

FIG. 6 represents a first intermediate unblocking step of the escapement device of FIG. 1, in which the first escapement mobile element begins to be released by the blocking mobile element via the first blocking tooth of the first escapement mobile element;

FIG. 7 represents a first pre-impulse step of the escapement device of FIG. 1, in which the first escapement mobile element begins to give an impulse to the blocking mobile element via the first blocking tooth of the first escapement mobile element;

FIG. 8 represents a second step called first-impulse step of the escapement device of FIG. 1, in which the first escapement mobile element gives an impulse to the blocking mobile element via a second blocking tooth of the first escapement mobile element;

FIG. 9 represents the end of the second step called first-impulse step of the escapement device of FIG. 8;

FIG. 10 represents a third step called second-rest step of the escapement device of FIG. 1, in which the second escapement mobile element is blocked by the blocking mobile element via a first blocking tooth of the second escapement mobile element;

FIG. 11 represents a second intermediate unblocking step of the escapement device of FIG. 1, in which the second escapement mobile element begins to be released by the blocking mobile element via the first blocking tooth of the second escapement mobile element;

FIG. 12 represents a second pre-impulse step of the escapement device of FIG. 1, in which the second escapement mobile element begins to give an impulse to the blocking mobile element via the first blocking tooth of the second escapement mobile element;

FIG. 13 represents a third step called second-impulse step of the escapement device of FIG. 1, in which the second escapement mobile element gives an impulse to the blocking mobile element via a second blocking tooth of the second escapement mobile element;

FIG. 14 represents the end of the third step called second-impulse step of the escapement device of FIG. 13;

FIG. 15 represents one variant of embodiment of the escapement device in the state of the first step called first-rest step of FIG. 5;

FIG. 16 represents the variant of embodiment of the escapement device of FIG. 15, in the state of the third step called second-rest step of FIG. 10;

FIG. 17 represents a first variant of embodiment of one alternative of the escapement device of FIG. 1 in which the first escapement mobile element and the second escapement mobile element comprise exclusively teeth provided to cooperate with the blocking mobile element and to cooperate with the other escapement mobile element, the escapement device of FIG. 17 being in the state of the first step called first-rest step;

FIG. 18 represents a second variant of embodiment of the alternative of the escapement device of FIG. 1 in which the first escapement mobile element and the second escapement mobile element comprise exclusively teeth provided to cooperate with the blocking mobile element and to cooperate with the other escapement mobile element, the escapement device of FIG. 18 being in the state of the first step called first-rest step.

### DETAILED DESCRIPTION OF EMBODIMENT(S)

FIG. 1 represents an escapement device according to the invention, comprising:
a first escapement mobile element 1 pivotally mounted about a first axis of rotation A1, arranged to be in engagement with a drive gear train 99 of the timepiece, and comprising a plurality of first blocking teeth,
a second escapement mobile element 2 pivotally mounted about a second axis of rotation A2 in engagement with the first escapement mobile element 1, and comprising a plurality of second blocking teeth,
a blocking mobile element 4 pivotally mounted about a third axis of rotation A4 and provided to alternately block the first escapement mobile element 1 and the second escapement mobile element 2, and to receive and transmit impulses to a balance 51 of an oscillator, as will be explained in detail below.

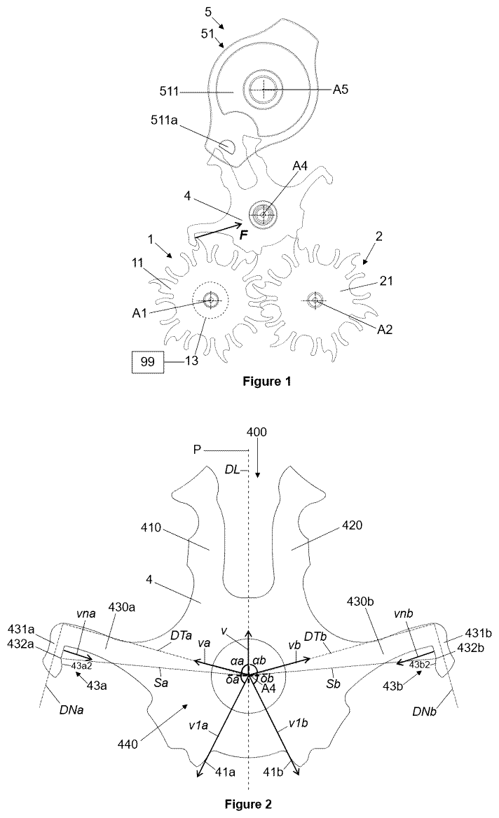

Particularly, the escapement device of FIG. 1 comprises:
the first escapement mobile element 1 pivotally mounted about the first axis of rotation A1, arranged to be engaged with the drive gear train 99 of the timepiece movement via a pinion 13, and comprising a plurality of first blocking surfaces 121a formed on first blocking teeth 121 (at their end) to cooperate with first blocking means 43a of the blocking mobile element 4, and a first driving toothing 111,
the second escapement mobile element 2 pivotally mounted about the second axis of rotation A2, comprising a plurality of second blocking surfaces 221a formed on second blocking teeth 221 (at their end) to cooperate with second blocking means 43b of the blocking mobile element 4, and a second driving toothing 211 engaged with the first driving toothing 111 to transmit the drive force from the first escapement mobile element 1 to the second escapement mobile element 2,
the blocking mobile element 4 (see FIG. 2) mobile in rotation about the third axis of rotation A4 and comprising:
   the first and second blocking means 43a, 43b arranged to block, during a rest phase, the first escapement mobile element 1 or the second escapement mobile element 2,
   impulse receiving means comprising impulse receiving portions 41a, 41b arranged to receive, during an impulse phase, an impulse from the first escapement mobile element 1 or from the second escapement mobile element 2,
   a fork 400 equipped with horns 410 and 420.

The oscillator comprises a balance 51 coupled to an elastic return member (typically a hairspring). The balance is pivotally mounted about a fourth axis of rotation A5, comprises a plate 511 and a pin 511a provided to cooperate with the fork 400 of the blocking mobile element 4.

It can be noted that the escapement device in FIG. 1 is an escapement device with tangential drive and two active vibrations, and FIG. 2 illustrates more specifically the blocking mobile element 4 which is provided to communicate the impulses received from the escapement mobile elements 1 and 2 to the oscillator 5 via the impulse-receiving means and their impulse-receiving portions 41a, 41b.

In FIG. 2, it can be noted that the blocking mobile element 4 comprises:
a body 440,
the first and second blocking means 43a, 43b disposed facing each other, each oriented towards the body 440 of the blocking mobile element, with in particular first and second blocking surface portions 43a1, 43b1 and first and second unblocking surface portions 43a2, 43b2 disposed facing each other, each oriented towards the body 440 of the blocking mobile element,
two receiving means taking the form of impulse receiving portions 41a, 41b also disposed facing each other,
the fork 400 equipped with the horns 410 and 420,
and it can be noted that the blocking mobile element has a plane of symmetry P passing between the horns 410, 420 and through the third axis of rotation A4.

The body 440 corresponds to the central part of the blocking mobile element 4, which comprises in particular a through hole defining the third axis of rotation A4 of the blocking mobile element.

Such an arrangement of the first and second unblocking surface portions 43a2, 43b2 allows the first or the second given escapement mobile element 1, 2 to apply a force on the blocking mobile element 4, which has the particularity of being oriented orthoradially or substantially orthoradially relative to the first or to the second axis of rotation A1, A2 of the first or the second given escapement mobile element during an unblocking step. In other words, the blocking force applied by the first or the second the escapement mobile element 1, 2 is orthogonal or substantially orthogonal to a radius of the first or the second escapement mobile element 1, 2 passing through the point of contact with the blocking mobile element 4 (during the considered rest phase).

The escapement device is thus not very sensitive to the potential variations in the coefficient of friction of the surfaces respectively in contact with the blocking mobile element 4 and with the first or the second given escapement mobile element 1, 2 during the unblocking steps.

According to the first variant of embodiment of the blocking mobile element 4 represented in FIG. 2, the first and second blocking means 43a, 43b comprise the unblocking surface portions 43a2, 43b2 and blocking surface portions 43a1, 43b1. Particularly, the first and second blocking means 43a, 43b are concave. Particularly, one flank of the blocking surface portions 43a1, 43b1 is adjacent to an unblocking surface portion 43a2, 43b2 to form a concavity.

Advantageously, such a variant of the blocking mobile element allows either of the escapement mobile elements 1 or 2 to immobilize the blocking mobile element 4 during a rest step, thanks to the orientation of the contact force between a blocking tooth of a given escapement mobile element and the blocking mobile element, which has the particularity of passing substantially in the vicinity of the axis of rotation A4, particularity passing through the axis of rotation A4 (FIG. 1). During an unblocking step following this rest step, this contact force is moreover oriented orthoradially or substantially orthoradially relative to the axis of rotation of the given escapement mobile element. Such a configuration guarantees that during unblocking, the reaction force applied between the blocking mobile element 4 and the escapement mobile element, which is then in contact with the blocking mobile element 4, is minimal and/or not very sensitive to butting phenomena and/or generates few variations in the friction force between the mobile elements in question.

Particularly, the first and second unblocking surface portions 43a2, 43b2 and/or the first and second blocking surface portions 43a1, 43b1 are oriented towards the plane of symmetry P of the blocking mobile element 4 passing through the third axis of rotation A4. That is to say, it is possible to identify vectors vna, vnb normal to the portions 43a2, 43b2 or 43a, 43b, which are oriented or directed towards the plane of symmetry P.

Particularly, according to one preferred example, the unblocking surface portions 43a2, 43b2 and/or the blocking surface portions 43a1, 43b1 are symmetrical with respect to the plane P.

The first and second impulse receiving portions 41a, 41b are also disposed facing each other symmetrically with respect to the plane P on the body 440 of the blocking mobile element 4.

The fork 400 protrudes from the body 440 along a first longitudinal direction DL parallel to the plane P, and along a direction opposite to that of the impulse receiving portions 41a, 41b. Particularly, this fork comprises the two horns 410, 420 arranged symmetrically with respect to the plane P, which extend away from the axis A4. Particularly, the fork 400 can be provided with two first portions called impulse portions, disposed facing each other and arranged to transmit to the inertial element, during the impulse phase, at least part of the impulse received from the escapement mobile elements 1 or 2, and the fork further comprises two second portions called abutment portions, disposed facing each other and each arranged protruding from one of the first portions, and each arranged to come into abutment with the inertial element if a shock is received by the movement of the timepiece, in particular during a rest phase.

The blocking mobile element 4 also comprises two arms 430a, 430b protruding from the body 440 along respectively first and second transverse directions DTa, DTb, and along two opposite directions.

The vectors va, vb, representing respectively the orientation DTa, DTb and the direction in which each of the arms 430a, 430b extends, are illustrated in FIG. 2. Each of these vectors forms an angle αa, αb of the order of 75° with a vector v comprised in the plane of symmetry P and representing the direction and the direction in which the fork 400 extends.

More generally, these angles αa, αb can be comprised between 70° and 120°. Preferably, αa is equal to αb. In other words, according to one preferred example, the arms 430a, 430b are symmetrical with respect to the plane P.

Each of the arms 430a, 430b comprises a beak 431a, 431b at its free end. Each beak 431a, 431b protrudes from its respective arm 430a, 430b along respectively a direction DNa, DNb, normal or substantially normal to the direction DTa, DTb, and along a direction opposite to that of the fork 400 and its horns 410, 420.

Preferably, the first and second blocking surface portions 43a1, 43b1, and the first and second unblocking surface portions 43a2, 43b2, are disposed on the internal flanks of the beaks 431a, 431b and extend along the respective directions DNa, DNb.

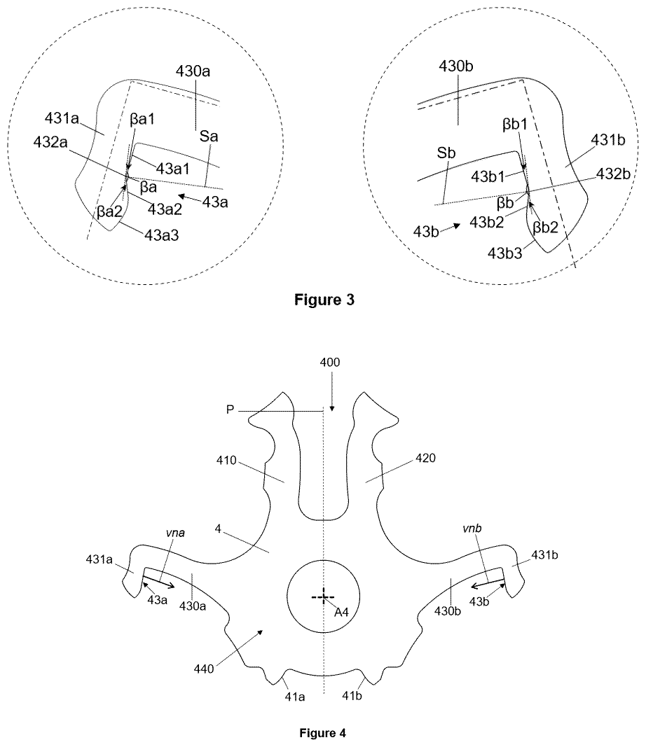

According to the first preferred variant of the blocking mobile element 4 (illustrated more specifically in FIGS. 2 and 3), the first and second blocking means 43a, 43b are concave, that is to say, they are formed of surfaces forming a V when viewed from the body 440 of the blocking mobile element, particularly from the third axis A4 of the blocking mobile element. Particularly, these first and second blocking means 43a, 43b comprise the first and second blocking surface portions 43a1, 43b1 and the first and second unblocking surface portions 43a2, 43b2 which meet at a point 432a, 432b, and which form respectively an angle βa, βb comprised in a range of values from 140° to 170°(FIG. 3). Particularly, the first and second unblocking surface portions 43a2, 43b2 are each here in the form of a planar surface portion or of a planar surface. The same applies to the first and second blocking surface portions 43a1, 43b1. Alternatively, these surface portions could be curved. Alternatively again, these surface portions could be composed of several continuous or discontinuous surfaces.

In the particular construction of FIGS. 2 and 3, these first and second blocking surface portions 43a1, 43b1 are inclined with respect to the normals to the segments Sa, Sb connecting the axis A4 and, respectively, the bearing points 432a, 432b. A first blocking surface portion 43a1 can for example form an angle βa1 of the order of 10° with respect to the normal to the straight line Sa. A first unblocking surface portion 43a2 can for example form an angle βa 2 of the order of 12° with respect to the normal to the straight line Sa. A second blocking surface portion 43b1 can for example form an angle βb 1 of the order of 10° with respect to the normal to the straight line Sb. A second unblocking surface portion 43b2 can for example form an angle βb2 of the order of 12° with respect to the normal to the straight line Sb.

If the first and second surface portions 43a1, 43a2, 43b1, 43b2 are curved, the angles βa1, βa2, βb1, βb2 could be determined by considering tangents to these surface portions.

The beaks 431a, 431b can also each comprise a first and a second impulse initiation surface 43a3, 43b3, formed in the continuity or in the extension of the first and second surfaces 43a2, 43b2, as will be explained below with the explanations relating to the operation.

According to a second variant of embodiment of the blocking mobile element 4, represented in simplified manner in FIG. 4, the first and second unblocking surface portions 43a2, 43b2 are in the form of a planar or curved surface.

Such a variant of blocking mobile element is shaped so as to be advantageously held, during the rest phases, against an abutment element under the effect of a tooth of either of the two escapement mobile elements 1 or 2 in contact with an unblocking surface portion 43a2, 43b2 (thus also acting as a blocking surface portion in cooperation with an abutment element).

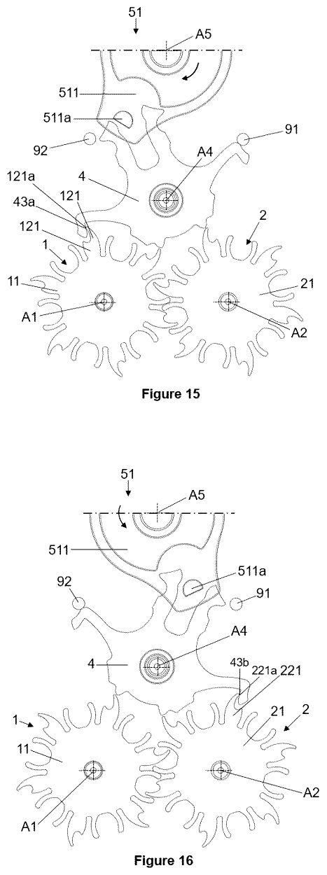

In FIGS. 15, 16, the abutment elements 91 and 92 are in the form of cotter pins or fixed detent pins relative to the timepiece movement provided to accommodate the escapement device. Alternatively, these abutment elements could be constituted by the teeth of the escapement mobile elements, particularly the distal surfaces 121a and 221a of the teeth 121 and 221 of the escapement mobile elements 1 and 2 (for example, the blocking tooth referenced 121 of the first escapement mobile element 1 in FIG. 15 can act as an abutment, or for example the blocking tooth referenced 221 of the second escapement mobile element 2 in FIG. 16 can act as an abutment).

Naturally, these abutment elements can cooperate with the blocking mobile element 4 at various points on the latter.

Of course, it is also possible, during the rest phases, to hold a blocking mobile element 4 in abutment according to the first preferred variant. In this case, the orientation of the reaction force between the components as well as the abutment element, contribute to immobilizing the blocking mobile element 4.

Regardless of the variant of embodiment, the same first escapement mobile element 1 is provided to cooperate successively, particularly during two successive rest and impulse steps (which follow each other immediately), with the first blocking means 43a and a first impulse receiving portion 41a.

Regardless of the variant of embodiment, the same second escapement mobile element is provided to cooperate successively, particularly during two successive rest and impulse steps (which follow each other immediately), with the second blocking means 43b and a second impulse receiving portion 41b.

The first blocking means 43a and the first impulse receiving portion 41a on the one hand, and the second blocking means 43b and the second impulse receiving portion 41b on the other hand, are each disposed on the same side of the plane P.

Particularly, the vectors va, vb form an angle δa, δb of the order of 80° with respectively a vector v1a, v1b passing through the third axis A4 and tangent respectively to the first and second impulse receiving portions 41a, 41b. More generally, this angle δa, δb can be comprised between 60° and 100°. Preferably, δa is equal to δb.

This blocking mobile element 4 is dedicated to sustain the oscillations of the oscillator 5 of FIG. 1 comprising an inertial element such as a balance 51 coupled to an elastic return element such as a hairspring. To do so, the fork 400, particularly the internal walls of the horns 410, 420, are provided to cooperate with a pin 511a of a plate 511 of the balance 51.

The escapement device is connected to a drive gear train 99, in particular via a wheel or a pinion 13 of the first escapement mobile element 1.

Preferably, the first and second escapement mobile elements 1 and 2 comprise in particular teeth 121, 221 (or first teeth or blocking teeth) in order to allow their meshing and also to allow their cooperation with the blocking mobile element 4. According to one particular variant, they also comprise branches 111, 211 (or second teeth or driving teeth) which are dedicated to contributing exclusively to the meshing of these first and second escapement mobile elements 1 and 2. The teeth and the branches are advantageously disposed on a single level.

According to one alternative to the implementation represented in FIGS. 1 to 14, the first and second escapement mobile elements 1, 2 could comprise respectively a first wheel comprising teeth (the blocking teeth 121 or 221) provided to cooperate exclusively with the blocking mobile element 4, and a second wheel comprising teeth or branches (the other teeth or branches of the first and second escapement mobile elements 1, 2) exclusively provided to allow the meshing of the mobile elements 1, 2. In this alternative, the operating mode of the escapement device is the same as that of the implementation represented in FIGS. 1 to 14.

The operating method of the escapement device of FIG. 1 will now be described.

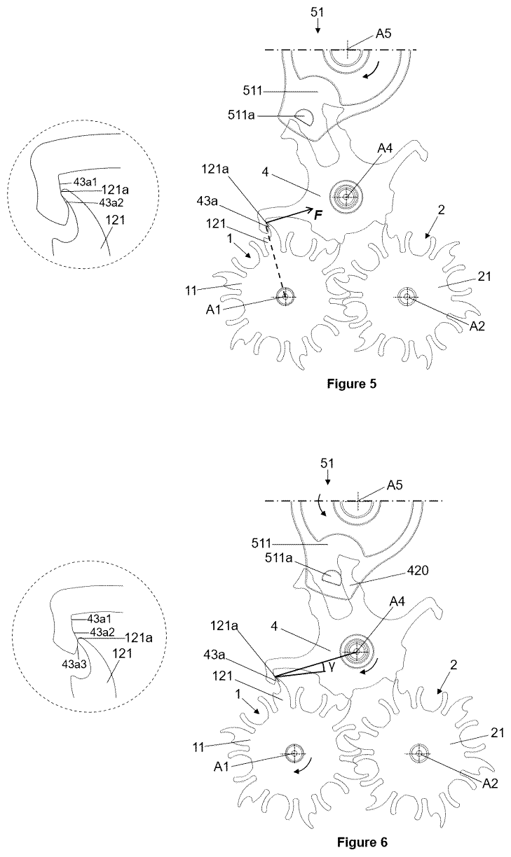

FIGS. 5 to 14 illustrate the different steps of the operating method of the escapement device, with a blocking mobile element 4 according to the first variant of embodiment in FIG. 1.

FIG. 5 illustrates a first step called first-rest step, in which a distal surface 121a of a first blocking tooth denoted 121 from the plurality of first blocking teeth of the first escapement mobile element 1 is in contact with the first blocking means 43a of the blocking mobile element 4, and particularly the distal surface 121a is in contact with the first blocking surface portion 43a1. During this step, the plate 511 of the balance 51 rotates initially clockwise (vibration N−1) and then counterclockwise (vibration N) under the effect of the elastic return of the hairspring.

FIG. 6 illustrates a first transitional step called “first intermediate unblocking step”, in which the pin 511a acts on the second horn 420 of the blocking mobile element 4 under the effect of the rotation of the balance 51, which now rotates counterclockwise (vibration N). This transitional step thus corresponds to a step of releasing the balance 51 or the balance plate 511. During this step, the blocking mobile element 4 and the first escapement mobile element 1 rotate in the same clockwise direction, like a paradoxical gear. This allows the distal surface 121a to move along the first blocking means 43a, particularly to move along the first unblocking surface portion 43a2 and reach the vertex of this first unblocking surface portion 43a2, thus to initiate the contact with the first impulse initiation portion 43a3 of the blocking mobile element 4.

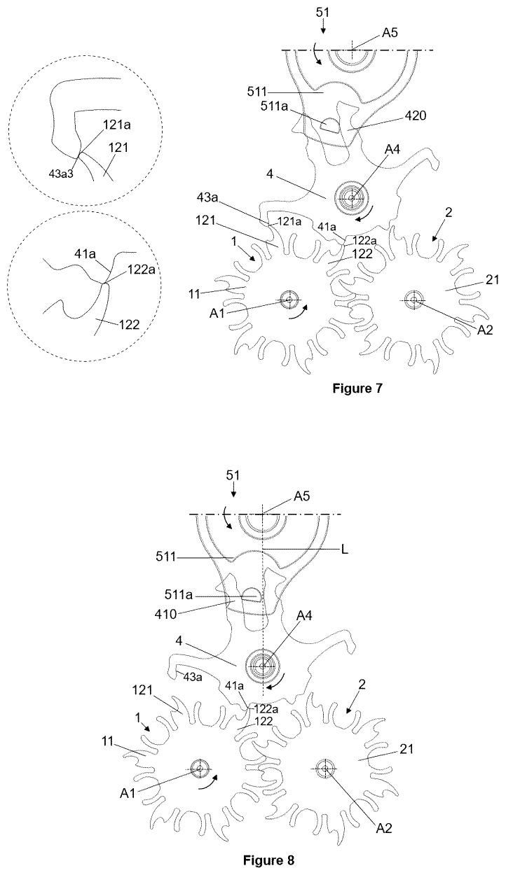

FIG. 7 illustrates a second transitional step (during the vibration N) called “first impulse initiation” step, in which the distal surface 121a of the first blocking tooth 121 from the plurality of first blocking teeth of the first escapement mobile element 1 actuates the first impulse initiation portion 43a3, until the distal surface 122a of a second blocking tooth denoted 122 from the plurality of first blocking teeth of the first escapement mobile element 1, successive to the first blocking tooth 121, comes into contact with the first impulse receiving portion 41a.

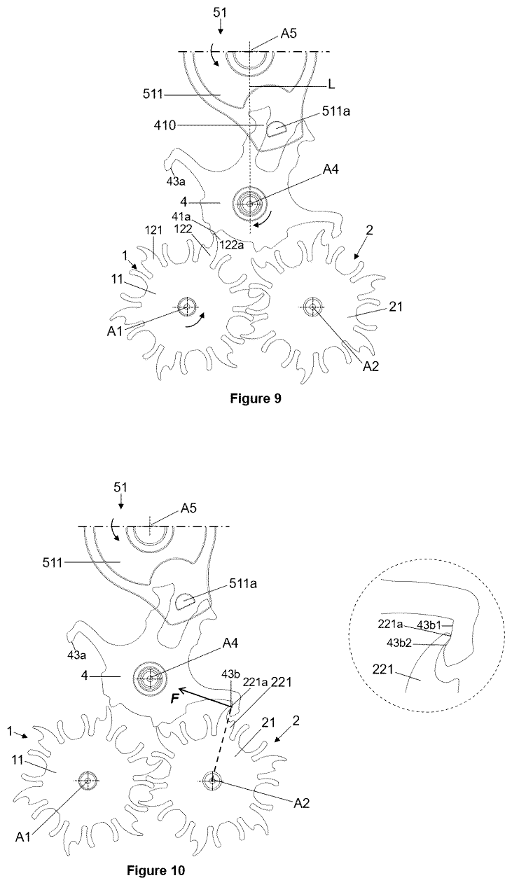

FIG. 8 illustrates a first phase of a second step called first-impulse step (during the vibration N), in which the distal surface 122a of the second blocking tooth 122 from the plurality of first blocking teeth of the first escapement mobile element 1 acts against the first impulse receiving portion 41a of the blocking mobile element 4, so that the horn 410 communicates an impulse to the pin 511a and so that the plate 511 of the balance thus continues its rotation counterclockwise (vibration N). FIG. 9 illustrates a second phase of the second step called first-impulse step, in which the pin 511a has passed the straight line of the centers L, still during the vibration N.

FIG. 10 illustrates a third step called second-rest step, in which a distal surface 221a of a first blocking tooth 221 from the plurality of second blocking teeth of the second escapement mobile element 2 is in contact with the second blocking means 43b of the blocking mobile element 4, and particularly the distal surface 221a is in contact with the second blocking surface portion 43b1. During this step, the plate 511 of the balance 51 rotates initially counterclockwise (end of the vibration N) and then clockwise (beginning of the vibration N+1) under the effect of the elastic return of the hairspring.

FIG. 11 illustrates a third transitional step called “second intermediate unblocking step”, in which the pin 511a acts on the first horn 410 of the blocking mobile element 4 under the effect of the rotation of the balance which now rotates clockwise (vibration N+1). This transitional step thus corresponds to a step of releasing the balance 51 or the balance plate 511. During this step, the blocking mobile element 4 and the second escapement mobile element 2 rotate in the same counterclockwise direction, like a paradoxical gear. This allows the distal surface 221a to move along the second blocking means 43b, particularly to move along the second unblocking surface portion 43b2 and to reach the vertex of this second unblocking surface portion 43b2, particularly to reach the vertex of the surface 43b2, and thus to initiate the contact with the second impulse initiation portion 43b3 of the blocking mobile element 4.

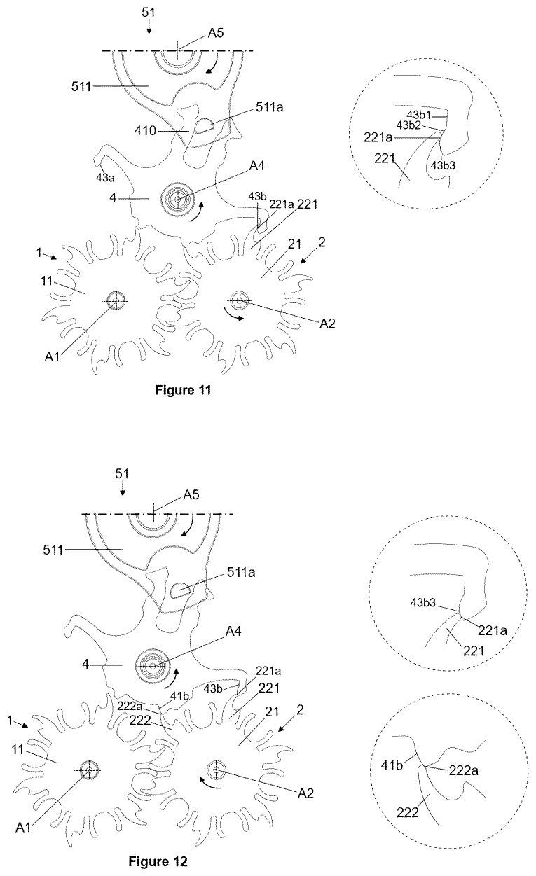

FIG. 12 illustrates a fourth transitional step (during the vibration N+1) called “second impulse initiation” step, in which the distal surface 221a actuates the second impulse initiation portion 43b3, until the distal surface 222a of a second blocking tooth denoted 222 from the plurality of second blocking teeth of the second escapement mobile element, successive to the first tooth 221, comes into contact with the second impulse receiving portion 41b.

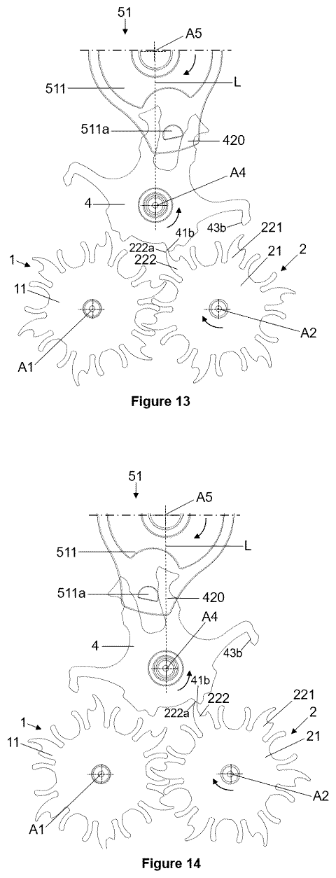

FIG. 13 illustrates the first phase of a fourth step called second-impulse step (during the vibration N+1), in which the distal surface 222a acts against the second impulse receiving portion 41b of the blocking mobile element 4, so that the horn 420 communicates an impulse to the pin 511a and so that the plate 511 of the balance thus continues its clockwise rotation. FIG. 14 illustrates the second phase of the fourth step called second-impulse step in which the pin 511a has passed the straight line of the centers L (vibration N+1).

At the end of this fourth step, the escapement device returns to the first rest step illustrated in FIG. 5. Thus, the operating method of the escapement device comprises a repetition of these different successive steps in order to sustain the oscillations of the hairspring-balance. This operating method is therefore a cyclic process that comprises a repetition of these different successive steps.

FIGS. 15 and 16 illustrate respectively the first and third steps, called first-rest and second-rest steps of the same escapement device, but with a blocking mobile element 4 according to the second variant of embodiment. During these first and third steps respectively, the blocking mobile element 4 is held against an abutment 91, 92 under the effect of the first and the second escapement mobile element 1, 2 respectively.

According to another alternative to the implementation represented in FIGS. 1 to 14, the first and second escapement mobile elements 1, 2 may comprise exclusively teeth provided to cooperate with the blocking mobile element 4 and to cooperate with another escapement mobile element to allow the meshing of the first and second escapement mobile elements.

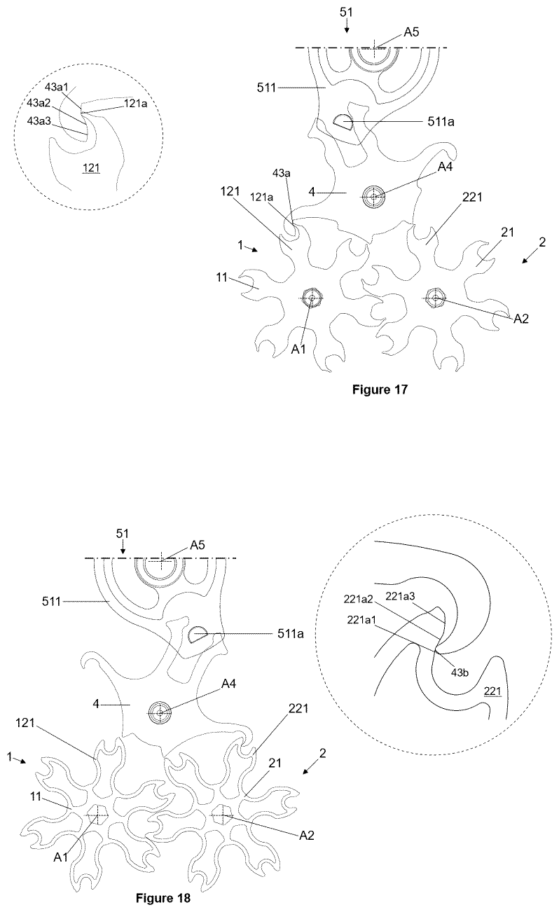

FIGS. 17 and 18 represent two variants of embodiment of this other alternative, in which the first and second escapement mobile elements 1, 2 comprise exclusively teeth provided to cooperate with the blocking mobile element 4 and to cooperate with the other escapement mobile element. Each of the teeth of an escapement mobile element is thus provided to cooperate with the blocking mobile element 4 during a given step in the method for operating the escapement device, but also provided to cooperate with another tooth of the other escapement mobile element during another step in the method for operating the escapement device.

FIGS. 17 and 18 each represent an escapement device of a timepiece, comprising:
a first escapement mobile element 1 arranged to be engaged with a drive gear train of the timepiece,
a second escapement mobile element 2 engaged with the first escapement mobile element 1,
a blocking mobile element 4 arranged to cooperate with an oscillator of the timepiece, in which:
the first escapement mobile element 1 comprises a first toothing comprising first blocking teeth 121,
the second escapement mobile element 2 comprises a second toothing comprising second blocking teeth 221,
the first escapement mobile element 1 is arranged to block the blocking mobile element 4 in a first rest position with one of the first blocking teeth 121 of the first toothing during a first step called first-rest step, followed by a second step called first-impulse step,
the second escapement mobile element 2 is arranged to block the blocking mobile element in a second rest position with one of the second blocking teeth 221 of the second toothing during a third step called second-rest step, followed by a fourth step called second-impulse step,
in which:
during the second step called first-impulse step, the first escapement mobile element 1 gives an impulse to the blocking mobile element 4, preferably with said first blocking teeth 121, and directly drives one of the second blocking teeth 221 of the second escapement mobile element 2 with another of the first blocking teeth 121,
during the fourth step called second-impulse step, the second escapement mobile element 2 gives an impulse to the blocking mobile element 4, preferably with said one of the second blocking tooth 221, and is driven directly via another of the second blocking teeth 221 by one of the first blocking teeth 121 of the first escapement mobile element 1.

For each of the variants of embodiment in FIGS. 17 and 18, the first and second escapement mobile elements 1, 2 cooperate together and each with the blocking mobile element 4 via the same blocking teeth 121 or 221. In other words, the first toothing (constituted by the first blocking teeth 121) allows the first escapement mobile element 1 to cooperate with the blocking mobile element 4 and with the second escapement mobile element 2, while the second toothing (constituted by the second blocking teeth 221) allows the second escapement mobile element 2 to cooperate with the blocking mobile element 4 and with the first escapement mobile element 1. Only one type of teeth (the first blocking teeth 121) ensures the contacts of the first escapement mobile element 1 with the blocking mobile element 4 and with the second escapement mobile element 2, and only one type of teeth (the second blocking teeth 221) ensures the contacts of the second escapement mobile element 2 with the blocking mobile element 4 and with the first escapement mobile element 1. The structure of the first and second escapement mobile elements 1, 2 can thus be simplified, their inertia can thus be reduced and their dimensions can be provided to reduce as much as possible the space requirement required by the escapement device.

For each of the variants of embodiment in FIGS. 17 and 18, it can be noted that the first blocking teeth 121 and the second blocking teeth 221 have a distal part with a fork, and a tooth root whose width is significantly smaller than that of the distal part, to allow a meshing between the first escapement mobile element 1 and the second escapement mobile element 2 without interference.

FIG. 17 represents the first variant of embodiment, in which the blocking and unblocking of the blocking mobile element 4 coincide with and/or are similar to the implementation of the escapement device of FIGS. 1 to 14. As shown particularly in the detailed view of FIG. 17, the first blocking surface portion 43a1, the first unblocking surface portion 43a2 and the first impulse initiation portion 43a3 are provided on the blocking mobile element 4 to cooperate with the distal surface 121a of each first blocking tooth 121.

FIG. 18 represents the second variant of embodiment, in which the first blocking surface portion, the first unblocking surface portion, and the first impulse initiation portion are transposed onto the blocking mobile element 4. The detailed view of FIG. 18 illustrates one end of a second blocking tooth 221 provided with a second blocking surface portion 221a1, a second unblocking surface portion 221a2 and a second impulse initiation portion 221a3, to cooperate with the distal surface of an arm of the blocking mobile element 4 forming second blocking means 43b. Industrial Application

An escapement device according to the present invention, and its manufacture, are capable of industrial application.

It will be understood that various modifications and/or improvements obvious to those skilled in the art can be made to the different embodiments of the invention described in the present description without departing from the framework of the invention.

Particularly, as shown in FIG. 17 or 18, the escapement mobile elements can be “solid” mobile elements (without recesses) or hollowed mobile elements. The same applies to the blocking mobile element. Furthermore, the escapement mobile elements can be identical or different in their shapes (identical or different toothings, monolithic and/or composite structures, integrally formed and/or assemblies, identical or different numbers of teeth, can be provided), or in their materials.

1. An escapement device of a timepiece, comprising:
at least one escapement mobile element arranged to be in engagement with a drive gear train (99) of the timepiece and comprising a plurality of blocking teeth,
at least one blocking mobile element, provided to:
block said at least one escapement mobile element during a rest step,
unblock said at least one escapement mobile element during an intermediate unblocking step, at the end of the rest step,
receive from said at least one escapement mobile element an impulse during an impulse step,
transmit at least part of the received impulse to an oscillator of the timepiece,
characterized in that, during a same vibration of the oscillator, the blocking mobile element is arranged to:
cooperate with a first blocking tooth from the plurality of blocking teeth to unblock said at least one escapement mobile element during the intermediate unblocking step,
cooperate with a second blocking tooth from the plurality of blocking teeth, different from said first blocking tooth, to receive from said at least one escapement mobile element the impulse during the impulse step subsequent to said intermediate unblocking step.

2. The escapement device according to claim 1, wherein said first blocking tooth, at least at the beginning of the intermediate unblocking step, is arranged to exert on the blocking mobile element a blocking force orthogonal, or substantially orthogonal, to a straight line passing through an axis of rotation of said at least one escapement mobile element and through a point of contact between said at least one escapement mobile element and the blocking mobile element.

3. The escapement device according to claim 1, wherein the blocking mobile element is arranged to cooperate with said first blocking tooth from the plurality of blocking teeth to block said at least one escapement mobile element during the rest step.

4. The escapement device according to claim 3, wherein said first blocking tooth, during the rest step, is arranged to exert a blocking force passing through, or substantially through, an axis of rotation of the blocking mobile element.

5. The escapement device according to claim 1, wherein the blocking mobile element comprises at least one unblocking surface portion and/or at least one blocking surface portion arranged to cooperate with said first blocking tooth during the intermediate unblocking step, and wherein said at least one unblocking surface portion and/or said at least one blocking surface portion is arranged to face an axis of rotation of the blocking mobile element, and/or wherein a line perpendicular to the unblocking surface portion or to the blocking surface portion is directed towards the axis of rotation of the blocking mobile element and forms, with a straight line passing through the axis of rotation of the blocking mobile element and through a point of contact between said at least one escapement mobile element and the blocking mobile element, an angle of less than 30°, preferably less than 20°, during the rest step or during the intermediate unblocking step.

6. The escapement device according to claim 5, wherein the blocking mobile element comprises said at least one unblocking surface portion and said at least one blocking surface portion,
wherein said at least one unblocking surface portion and said at least one blocking surface portion are adjacent and separated by a bearing point, and wherein the blocking surface portion and the unblocking surface portion preferably form an angle comprised in a range of values from 140° to 170°.

7. The escapement device according to claim 1, wherein said first blocking tooth and said second blocking tooth are subsequent or adjacent, and/or wherein a rotation of the blocking mobile element and a rotation of the escapement mobile element during the impulse step are in opposite directions.

8. The escapement device according to claim 1, comprising:
a first escapement mobile element pivotally mounted about a first axis of rotation, arranged to be in engagement with the drive gear train of the timepiece, and comprising a plurality of first blocking teeth,
a second escapement mobile element pivotally mounted about a second axis of rotation, in engagement with the first escapement mobile element, and comprising a plurality of second blocking teeth,
wherein the blocking mobile element is pivotally mounted about a third axis of rotation,
and wherein:
during a first vibration of the oscillator, the blocking mobile element is arranged to:
cooperate with a first blocking tooth from the plurality of first blocking teeth to unblock the first escapement mobile element, during a first intermediate unblocking step, at the end of a first step called first-rest step,
cooperate with a second blocking tooth from the plurality of first blocking teeth, different from said first blocking tooth, to receive from the first escapement mobile element an impulse during a second step called first-impulse step, subsequent to said first intermediate blocking step,
during a second vibration of the oscillator, the blocking mobile element is arranged to:
cooperate with a first blocking tooth from the plurality of second blocking teeth to unblock the second escapement mobile element, during a second intermediate unblocking step, at the end of a third step called second-rest step,
cooperate with a second blocking tooth from the plurality of second blocking teeth, different from said first blocking tooth, to receive from the second escapement mobile element an impulse during a fourth step called second-impulse step, subsequent to said second intermediate unblocking step.

9. The escapement device according to claim 8, wherein the blocking mobile element comprises:
a first unblocking surface portion and/or a first blocking surface portion arranged to cooperate with said first blocking tooth from the plurality of first blocking teeth,
a second unblocking surface portion and/or a second blocking surface portion arranged to cooperate with said first blocking tooth from the plurality of second blocking teeth,
and wherein:
the first unblocking surface portion and the second unblocking surface portion are arranged facing each other, and/or
the first blocking surface portion and the second blocking surface portion are arranged facing each other.

10. The escapement device according to claim 9, wherein:
the blocking mobile element comprises:
the first unblocking surface portion and the first blocking surface portion,
the second unblocking surface portion and the second blocking surface portion,
and wherein:
the first unblocking surface portion and the first blocking surface portion are adjacent and separated by a first bearing point, wherein the first unblocking surface portion and the first blocking surface portion preferably form an angle comprised in a range of values from 140° to 170°,
the second unblocking surface portion and the second blocking surface portion are adjacent and separated by a second bearing point, wherein the second unblocking surface portion and the second blocking surface portion preferably form an angle comprised in a range of values from 140° to 170°,
and wherein a triangle whose vertices are the third axis of rotation, the first bearing point and the second bearing point, has at the vertex of the third axis of rotation, an angle greater than 150°.

11. The escapement device according to claim 8, wherein:
during the first intermediate unblocking step, the first escapement mobile element and the blocking mobile element pivot in identical directions of rotation;
during the second step called first-impulse step, the first escapement mobile element and the blocking mobile element pivot in opposite directions of rotation;
during the second intermediate unblocking step, the second escapement mobile element and the blocking mobile element pivot in identical directions of rotation;
during the fourth step called second-impulse step, the second escapement mobile element and the blocking mobile element pivot in opposite directions of rotation.

12. The escapement device according to claim 8, wherein:
during the first intermediate unblocking step, the first blocking tooth from the plurality of first blocking teeth is arranged to exert on the blocking mobile element a first blocking force orthogonal, or substantially orthogonal, to a straight line passing through the first axis of rotation and through a point of contact between the first escapement mobile element and the blocking mobile element, and/or the first blocking force passes through, or substantially through, the third axis of rotation,
during the second intermediate unblocking step, the first blocking tooth from the plurality of second blocking teeth is arranged to exert on the blocking mobile element a second blocking force orthogonal, or substantially orthogonal, to a straight line passing through the second axis of rotation and through a point of contact between the second escapement mobile element and the blocking mobile element, and/or the second blocking force passes through, or substantially through, the third axis of rotation.

13. A method for sustaining the oscillations of an oscillator in a timepiece, the timepiece comprising at least:
an oscillator arranged to have periodic oscillations,
a drive gear train arranged to generate a drive force, comprising for example a mainspring such as a barrel spring,
an escapement device arranged between the oscillator and the drive gear train, comprising at least a first escapement mobile element movable in rotation and comprising a plurality of first blocking teeth, a second escapement mobile element movable in rotation, comprising a plurality of second blocking teeth and engaged with the first escapement mobile element, and a blocking mobile element movable in rotation,
the method for sustaining the oscillations comprising at least:
a first step called first-rest step, during which the first escapement mobile element cooperates with the blocking mobile element so as to block the blocking mobile element in a first blocking position,
a second step called first-impulse step, during which the first escapement mobile element drives the blocking mobile element along a first predefined impulse path,
a third step called second-rest step, during which the second escapement mobile element cooperates with the blocking mobile element so as to block the blocking mobile element in a second blocking position,
a fourth step called second-impulse step, during which the second escapement mobile element drives the blocking mobile element along a second predefined impulse path.

14. The method for sustaining the oscillations according to claim 13, comprising:
a first intermediate unblocking step, interposed between the first step called first-rest step and the second step called first-impulse step, during which the first escapement mobile element and the blocking mobile element pivot in a same first direction of rotation, and/or
a second intermediate unblocking step, interposed between the third step called second-rest step and the fourth step called second-impulse step, during which the second escapement mobile element and the blocking mobile element pivot in a same second direction of rotation.

15. The method for sustaining oscillations according to claim 14, wherein:
the first intermediate unblocking step is implemented by the cooperation of the blocking mobile element and of a first blocking tooth from the plurality of first blocking teeth, and preferably ends with a first pre-impulse step consisting in transmitting to the blocking mobile element part of the impulse via the first tooth from the plurality of first blocking teeth, the second step called first-impulse step being implemented by the cooperation of the blocking mobile element and of a second tooth from the plurality of first blocking teeth, and/or
the second intermediate unblocking step is implemented by the cooperation of the blocking mobile element and of a first blocking tooth from the plurality of second blocking teeth, and preferably ends with a second pre-impulse step consisting in transmitting part of the impulse via the first tooth from the plurality of second blocking teeth, the fourth step called second-impulse step being implemented by the cooperation of the blocking mobile element and of a second tooth from the plurality of second blocking teeth.
